(19) United States
(12) Patent Application Publication
(10) Pub. No.: US 2016/0346691 A1
(43) Pub. Date: Dec. 1, 2016

(54) Golf Scoring System

(71) Applicants: Wallace McClure, Knoxville, TN (US); Arthur Long, III, Knoxville, TN (US)

(72) Inventors: Wallace McClure, Knoxville, TN (US); Arthur Long, III, Knoxville, TN (US)

(21) Appl. No.: 15/167,016

(22) Filed: May 27, 2016

Related U.S. Application Data
(60) Provisional application No. 62/167,471, filed on May 28, 2015.

(51) Int. Cl. A63F 13/46; A63F 13/335; A63F 13/25

(52) U.S. Cl. CPC A63F 13/46; A63F 13/25; A63F 13/335

(57) ABSTRACT

A method for electronically scoring a golf event by participating members of a golf group is provided. The method includes providing a scoring database in communication with participant devices having a user interface, storing data related to a plurality of participants in a golf game, assigning each of the participants in a golf game to playing groups competing, designating one of the participants in each playing group as the group scorekeeper, generating a scorekeeper input page that includes a list of each participant assigned to the group scorekeeper's group, generating a golf game scoreboard including a real-time score of participants in the golf game, receiving participant individual hole scores from the participant device of the group scorekeeper, storing the received participant hole scores on the scoring database, and updating the scoreboard to display scores of the golf game based on received hole scores received from the group scorekeeper.

### CROSS-REFERENCE TO RELATED APPLICATION

This application claims priority to U.S. patent application Ser. No. 62/167,471 to Wallace McClure and Arthur Long for an Electronic Golf Scoring System, which was filed on May 28, 2015, the contents of which are incorporated herein by reference in its entirety.

### FIELD

This disclosure relates to the field of portable event real time scoring systems and scoring data manipulation and display systems. More particularly, this disclosure relates to a system(s) for real time scoring individual golf events by participants of the golf events, for the manipulation of the scoring data for display in various formats, and the use of said data for management of play, calculation of results and wagers in various formats, the historical posting of results (i.e., into GHIN system), and statistical analysis.

### BACKGROUND

Participants in a game of golf may compete in various types of games involving multiple golfers in various groups. For example, golf games may be arranged in different formats such as best ball/select shot, scramble, low ball(s), alternate shot, and other various formats involving teams or individuals. Additionally, games may be individual or team events and may utilize gross or net (handicapped) scores. Golf Clubs or courses may have regular games played by members/players of the particular course, such as a weekly scramble or other type of event. Typically, when these games are concluded, final scoring must be calculated by hand. During a game it may be impossible for participants to know in real time where that participant ranks with respect to other competitors in the same game, or for third parties not participating to follow progress of participants or teams within the game. The games may also involve multiple and complex wagers, monetary or otherwise, that involve multiple time consuming determinations at the end of an event.

Additionally, the pace of play, during normal club play and events, is a rising problem/consideration for Golf Clubs. While PGA Tour events have officials present to monitor and enforce a proper pace of play, daily play and Golf Club events often do not.

While various systems have been developed to track scoring during a golf event, these systems are configured to allow a scorekeeper or other non-participant to enter scores related to the golf event. These golf events typically include formal stroke play tournaments, such as PGA Tour or other large-scale events. These events are typically focused on a specific event type; such as stroke play or match play type events. As such, these systems are not configured for daily use during ordinary games of multiple formats at a golf course, nor do these systems allow scores to be entered and tracked in real time by various participants in the game or non-participating third parties, but instead require spotters or other third parties to follow participants and enter scores. Finally, participants of events may have various “side games” occurring during an event, and it may be desirable to track the status of the side games in real time during the event.

What is needed, therefore, is an electronic golf scoring system for multiple game formats such as individual or team events, gross or net events, variable number of balls to be scored, multiple divisions of play within a single event, single or multi-day events, multiple types of games, multiple scoring parameters, wager calculations, and other scoring parameters, configured to allow participants of a golf game to track their score and to further allow participants to track in real time their position in relation to other participants in the game. Additionally, the system(s) need to provide the Golf Club or event host a methodology to monitor and enforce the proper pace of play.

### SUMMARY

The above and other needs are met by an electronic golf scoring system for facilitating scorekeeping of participants in a casual golf game by other participants of the game. In a first aspect, a method for electronically scoring a golf event by participating members of a golf group, the method is provided including: (1) providing a scoring database including a processor and one or more computer readable storage mediums, the scoring database in wireless communication with a plurality of participant devices, each of the plurality of participant devices including a user interface; (2) storing on the computer readable storage medium of the scoring database data related to an identification of a plurality of participants in a golf game; (3) assigning each of the plurality of participants in a golf game to one of a plurality of playing groups competing in the golf game; (4) designating on the scoring database one of the plurality of participants in each playing group as the group scorekeeper; (5) generating a scorekeeper input page displayed on the participant device of the designated group scorekeeper comprising a list of each participant assigned to the group scorekeeper's playing group; (6) generating a golf game scoreboard viewable on a display, the golf game scoreboard including real-time score of participants in the golf game; (7) receiving participant individual hole scores for each member of the designated group scorekeeper's playing group on the scorekeeper input page displayed from the participant device of the group scorekeeper; (8) storing the received participant hole scores on the computer readable storage medium of the scoring database and associating the received score with each participant on the scoring database; and (9) updating the generated golf game scoreboard to display scores of the golf game based on received participant individual hole scores received from the participant device of the group scorekeeper.

In one embodiment, the method further includes: (10) receiving a request from a participant device of a group scorekeeper requesting designation of a new group scorekeeper on the scoring database, the request including an identity of another participant in the scorekeeper's playing group; (11) designating the identified participant in the scorekeeper's playing group as the new group scorekeeper on the scoring database; (12) generating a scorekeeper input page displayed on the participant device of the newly designated group scorekeeper; and (13) receiving participant individual hole scores for each member of the designated group scorekeeper's playing group on the scorekeeper input page displayed from the participant device of the new group scorekeeper.

In another embodiment, the method further includes transmitting a notification to the participant device of the participant identified in the designation request to notify the participant that the participant is now the group scorekeeper.

In yet another embodiment, the method further includes: receiving a request from a participant device to initiate a side game, the request including identification of one or more other golf game participants and a side game format; generating a side game on the scoring database based on the received request and associating the side game with the identified golf game participants; generating a side game scoreboard, the side game scoreboard based on individual hole scores received on the scoring database from the participant device of the group scorekeeper.

In one embodiment, the format of the side game is different from the golf game format. In another embodiment, the method further includes: assigning the participants in the golf game into two or more teams, an identity of the teams stored on the scoring database; assigning a golf game format to the two or more teams stored on the scoring database; determining on the scoring database a score of the golf game based on the assigned golf game format and scores received on the scoring database from one or more group scorekeepers of the golf game; wherein the generated golf game scoreboard includes the determined team score of the golf game.

In yet another embodiment, scores received from at least one group scorekeeper include scores corresponding to participants of more than one team within the same group, and wherein the scoring database associates the received scores of participants from more than one team into the correct team scores. In one embodiment, the generated scorekeeper input page displays an input field for entry of a single hole score. In another embodiment, the method further includes providing a clubhouse device in electronic communication with the scoring database.

In one embodiment, the method further includes: receiving a request from a clubhouse device in electronic communication with the scoring database requesting designation of a new group scorekeeper on the scoring database, the request including an identity of another participant in the scorekeeper's playing group; designating the identified participant in the clubhouse device request as the new group scorekeeper on the scoring database; generating a scorekeeper input page displayed on the participant device of the newly designated group scorekeeper; and receiving participant individual hole scores for each member of the designated group scorekeeper's playing group on the scorekeeper input page displayed from the participant device of the new group scorekeeper.

In another embodiment, the method further includes receiving an identity of participants in a golf game and a golf game format from the clubhouse device.

In yet another embodiment, the method further includes: receiving on the scoring database data related to a handicap rating of one or more participants of the golf game; associating the received handicap data with the one or more participants of the golf game; and determining on the scoring database a net score of one or more participants of the golf game based on the received participant handicap data and the participant scores received from the group scorekeeper.

In one embodiment, the method further includes determining on the scoring database a pace of play of a group based on a time at which the scoring database receives participant hole scores from the group scorekeeper.

In another embodiment, the method further includes: generating an event web page accessible by an event planner device, the web page including one or more data fields for receiving data related to an identity of one or more participants in a golf event and a format of a golf event; creating a golf event on the scoring database based on data entered by an event planner on the event web page; grouping the one or more identified participants into two or more teams on the scoring database; grouping the one or more identified participants into two or more playing groups on the scoring database; and designating one participant from each of the two or more playing groups as a group scorekeeper.

In one embodiment, the method further includes transmitting a hyperlink to the plurality of participant devices in communication with the scoring database, the hyperlink including a token generated on the scoring database that is associated with a particular participant.

In another embodiment, the method further includes: generating a non-scorekeeping participant input page displayed on non-scorekeeping participants of the playing group; receiving a hole score for the non-scorekeeping participant from participant device of the non-scorekeeping participant; storing the received participant hole score on the computer readable storage medium of the scoring database and associating the received score with the particular non-scorekeeping participant; and updating the generated golf game scoreboard to display the received participant hole score, wherein the displayed participant score hole replaces the score received from the participant device of the group scorekeeper.

In a second aspect, a method for electronically scoring a golf event by participating members of a golf group is provided including: (1) providing a scoring database including a processor and one or more computer readable storage mediums, the scoring database in wireless communication with a plurality of participant devices, each of the plurality of participant devices including a user interface; (2) storing on the computer readable storage medium of the scoring database data related to an identification of a plurality of participants in a golf game; (3) assigning each of the plurality of participants in a golf game to one of a plurality of playing groups competing in the golf game; (4) designating on the scoring database one of the plurality of participants in each playing group as the group scorekeeper; (5) generating a scorekeeper input page displayed on the participant device of the designated group scorekeeper comprising a list of each participant assigned to the group scorekeeper's playing group; (6) generating a golf game scoreboard viewable on a display, the golf game scoreboard including real-time score of participants in the golf game; (7) receiving participant individual hole scores for each member of the designated group scorekeeper's playing group on the scorekeeper input page displayed from the participant device of the group scorekeeper; (8) storing the received participant hole scores on the computer readable storage medium of the scoring database and associating the received score with each participant on the scoring database; (9) updating the generated golf game scoreboard to display scores of the golf game based on received participant individual hole scores received from the participant device of the group scorekeeper; (10) receiving a request from a participant device of a group scorekeeper requesting designation of a new group scorekeeper on the scoring database, the request including an identity of another participant in the scorekeeper's playing group; (11) designating the identified participant in the scorekeeper's playing group as the new group scorekeeper on the scoring database; (12) generating a scorekeeper input page displayed on the participant device of the newly designated group scorekeeper; and (13) receiving participant individual hole scores for each member of the designated group scorekeeper's playing group on the scorekeeper input page displayed from the participant device of the new group scorekeeper.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 illustrates an electronic golf scoring system according to one embodiment of the disclosure;

FIG. 2 illustrates a user interface displayed to a scorekeeping participant on a participant device according to one embodiment of the disclosure;

FIG. 3 illustrates a hand-off feature of the electronic scoring system according to one embodiment of the disclosure;

FIG. 4 illustrates an exemplary real-time scoreboard of the electronic golf scoring system according to one embodiment of the disclosure;

FIG. 5 shows a mobile scoreboard summary of an event, in this instance a match play event, in progress according to one embodiment of the disclosure;

FIG. 6 shows an embodiment of the electronic golf scoring system that is not dependent upon an outside infrastructure, but instead relies on an infrastructure owned and operated by a golf course;

FIG. 7-9 shows a general set up screen according to one embodiment of the disclosure;

FIG. 10 shows a screen for setting up wager points during a set up process according to one embodiment of the disclosure;

FIGS. 11 and 12 show a screen for adding participants to an event according to one embodiment of the disclosure;

FIG. 13 shows a screen listing participants who have recently participated in a similar event to an event being set up for being added to a new event according to one embodiment of the disclosure;

FIG. 14 shows a set up screen for designating a team size and use of “blind bogey” players according to one embodiment of the disclosure. (A Blind Bogey player is a fictional player with a predetermined score used when another player is needed to balance the number of participates);

FIGS. 15 and 16 show a list of participants and creation of teams according to one embodiment of the disclosure;

FIG. 17 is a display of created teams of participants according to one embodiment of the disclosure;

FIG. 18 shows a display for making changes to participants on a team and tees for a participant, as well as an option to finalize teams and start an event according to one embodiment of the disclosure;

FIGS. 19 and 20 show a scoreboard of an electronic golf scoring system according to one embodiment of the disclosure;

FIG. 21 shows a scoreboard for an event displaying gross scores of participants according to one embodiment of the disclosure;

FIG. 22 shows a mobile scoreboard for a net game event according to one embodiment of the disclosure;

FIG. 23 shows a display for creating an output of specific holes during an event according to one embodiment of the disclosure;

FIG. 24 illustrates a display for inputting scores of participants on a team according to one embodiment of the disclosure;

FIG. 25 shows a scoreboard for a gross score multi-day event according to one embodiment of the disclosure; and

FIG. 26 illustrates a real-time bracket according to one embodiment of the disclosure.

FIG. 27 illustrates an official scoreboard presented on a tablet device to be used when the signatures of a player and his attesting partner are required.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control. Additionally, certain words and terms have meaning in golf and are generally accepted without further definition.

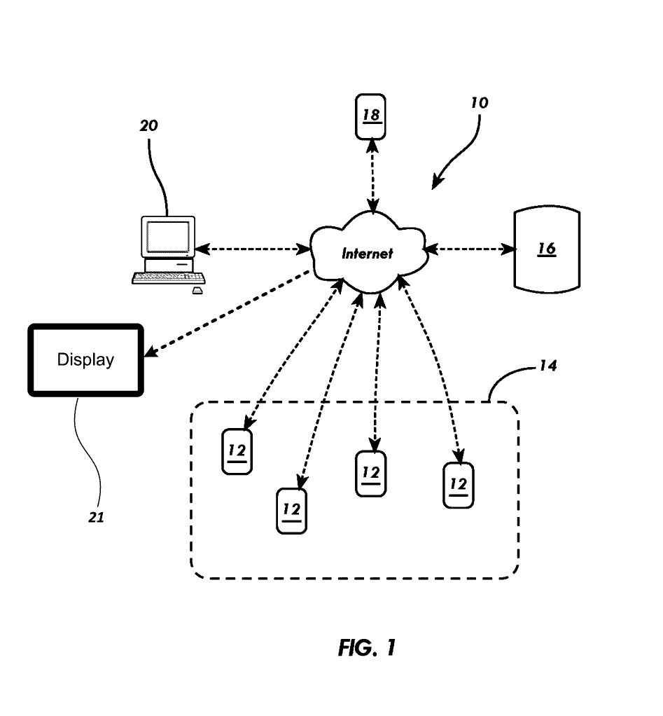

FIG. 1 shows a basic embodiment of an electronic golf scoring system 10 including one or more participant devices 12 in use by participants on a golf course 14 and a scoring database 16. Participants in a golf game may enter hole-by-hole scores on the participant devices 12, which then transmit the scores to the scoring database 16. Scores are then viewable by other participants of the golf game via a real-time scoreboard displayed on the participant devices 12 or viewed on fixed displays 21 in or around a club house, pro shop or golf course. Further, scores may be viewed by one or more third party devices 18, and games may be initially set up and orchestrated by a clubhouse device 20.

The one or more participant devices 12 are preferably in communication with the scoring database 16 via the Internet. The participant devices may comprise, for example, personal devices (iPhone®, iPad®, iPod®, Android®, and other like devices) that are in communication with the Internet via a wireless connection, such as a cellular radio, Wi-Fi, or other like wireless connection. The scoring database 16 includes at least a processor and a computer readable storage medium for storing data on the scoring database 16. The scoring database 16 is preferably located remotely from the golf course 14, such as at one or more remote databases. However, it is also understood that the scoring database 16 may be installed and located at the golf course 14 and that the one or more participant devices communicate with the scoring database via a local network.

### Game Setup

Initially a golf game may be created by an administrator or participant in a golf game. In one embodiment, a golf game is initially setup by an administrator, such as a golf course professional or staff member, using the clubhouse device 20. The clubhouse device 20, which is in communication with the scoring database 16, includes a user interface for setting up an initial golf game. For example, the user interface may comprise a stand-alone application (hereinafter referred to as an “App”) or, alternatively, a user interface provided via a web browser.

The administrator initially creates a game selecting a list of participants. The administrator may enter each participant manually along with information related to each participant such as the participant's email address, handicap index, tee location, and other various information related to each participant. Alternatively, a list of potential participants may be stored on or otherwise retrieved by the scoring database 16, such as members of a golf club or a list of participants who regularly participate in a particular game. For example, if the same participants typically play in a game at a designate time during the week, that particular game and the associated participants may be stored on the scoring database 22 such that the administrator may readily create regular weekly games.

The scoring database may also store or retrieve information related to a participant, such as the participant's handicap or contact information. For example, the scoring database may automatically retrieve a participant's handicap index, email address, and other related information from the Golf Handicap and Information Network (“GHIN”) such that a participant's most current handicap index is used during a golf game.

The administrator further designates a type of game to be played. Such games may include, but are not limited to, select shot, alternate shot, best ball, low ball, four ball, foursome, scramble, stroke play (team or individual), match play (team or individual), and other various types of golf games. If the selected golf game is a team event, the administrator may select team sizes along with potential captains of each team. Captains may also be determined automatically by the system selecting the lowest handicapped player. Other golf game parameters may be set such as whether net or gross scores are to be used, an amount of wager points required to participate in a particular game, and whether any additional games are desired such as the awarding of “skins,” birdies, “greenies,” and “sandies” to individuals during the golf game. Wager points may be associated with various portions of a particular game. For example, points for a front nine, back nine, 18 holes, “skins,” etc. may be assigned.

After designating participants of a golf game, the administrator may assign participants to particular teams. Alternatively, the administrator may designate captains and the captains are thereafter allowed to pick teams based on available participants in the golf game. In one embodiment, after all participants have signed up, team captains may pick participants for each captain's team from the available participants using the captain's participant device 12. Captains may pick using a straight draw, where captain's pick in order, or using a “snake” draw, where a first captain picks are made in order and second captain picks are in reverse order.

In another embodiment, participants may be automatically assigned to teams. Participants may be automatically assigned based on a participant's handicap index, or alternatively assigned at random.

While the above contemplates an administrator initializing a game and inviting participants, it is also understood that embodiments of the electronic golf scoring system would also allow various participants to create a golf game and invite participants to play in the golf game, wherein the participant creating the golf game is able to select all of the various parameters of the game that can be entered by the administrator referenced above.

In one embodiment, the electronic golf scoring system 10 is configured to work at an “away” golf course, such as a golf course that does not already utilize the electronic golf scoring system 10 of the present disclosure. A group of participants may create an event at an away golf course including a type of game, number of participants, and other parameters of a golf game to be played using the participant devices 12. The participant devices 12 may transmit scores to the scoring database 16, thereby allowing the participants to set up a golf game without requiring any resources of the away golf course. In this embodiment, the signup process and the selection of teams by captains, or otherwise, may be accomplished when the parties are in different locales.

Multi-day golf events may be created in the scoring database 16 such that the scoring database 16 tracks scores and provides a scoreboard of participant's progress over multiple games or days of golf. For example, when one or more participants attend a golf trip to one or more different courses over a period of several days, scores from each day may be stored on the scoring database 16 and overall results tracked. In another example, a multi-day golf event at a Golf Club, such as a standard stroke play tournament, may be created, maintained, recorded, and displayed.

Finally, if a number of participants does not allow for teams with equal numbers of participants, various “blind bogeys” or “phantom players” may be stored on the scoring database 22 such that if additional participants are needed to complete teams in a particular golf event, a blind bogey may be assigned to one or more teams of the golf event. Each blind bogey may have a pre-designated score for a round of golf saved for the blind bogey, and the blind bogey score may contribute to each team's overall score. Blind bogeys may be automatically generated by the scoring database and assigned to teams or, alternatively, one or more pre-designated blind bogeys may be maintained for a particular golf course or a particular golf event for use by the participants.

The scoring database 16 may be in communication with a golf course tee-time system, such as ForeTees or other like systems. After a new game is set up, in one embodiment teams of participants may be transmitted to the golf course tee-time system to check for available tee-times and create required tee-times and list participants requesting tee-times in association with a particular event.

### Scorekeeping

The electronic golf scoring system 10 is configured to receive scores entered by participants on the one or more participant devices 12 and to associate and store those scores with a particular game in which the participant is competing. In a team game, scores of a particular team are preferably entered by one scorekeeping participant of each team, but may be entered by individual players.

Data related to an identification of a plurality of participants in a golf game are stored on a computer readable storage medium of the scoring database 16. Data may include the participant's name, handicap index rating, tee location, and other information related to each participant.

After the participants are assigned into one or more teams, the participants are further assigned to one of a plurality of playing groups competing in a golf game. Participants may be assigned to groups based on teams. For example, if each team consists of four players, a participant group may be comprised of the four players on the same team. In other examples, such as where each team includes an odd number of players, participants may be assigned to one or more playing groups randomly by the scoring database 16, or according to preferences of the one or more participants.

After designating a plurality of playing groups comprising participants of the golf game, one participant of each playing group is designated by the scoring database 16 as the group scorekeeper. The scoring database 16 may automatically designate a participant of a playing group as the group scorekeeper, such as designating a captain or participant of a group having the lowest handicap index as the default scorekeeping participant.

After designating a scorekeeping participant, the scoring database 16 generates a scorekeeper input page that is displayed on the participant device of the designated group scorekeeper. The scorekeeper input page may be, for example, a web page accessible by the scorekeeper's participant device. The scorekeeper input page includes a list of participants assigned to that particular group scorekeeper's playing group, along with input fields for receiving a score from each group participant on a particular hole. The group scorekeeper inputs participant scores for each participant on a particular hole, and transmits the participant scores to the scoring database 16 where they are stored on the computer readable storage medium of the scoring database 16. Each score is stored on the scoring database 16 and associated with the corresponding participant.

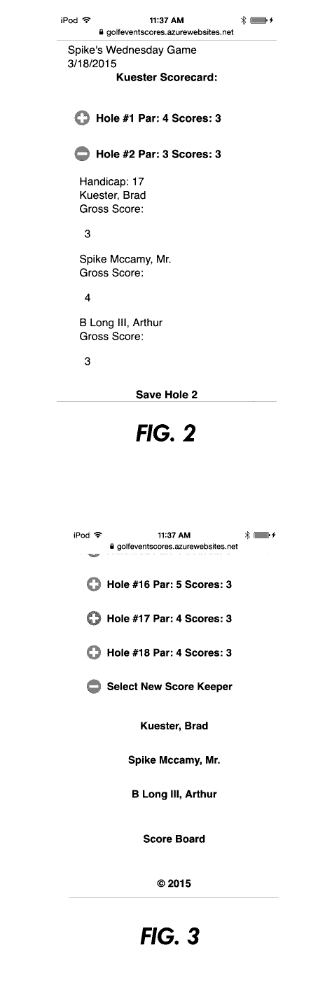

For example, FIG. 2 shows a user interface displayed to a scorekeeping participant on the participant device 12 that allows the scorekeeping participant of a particular team to enter scores not only for the scorekeeping participant but also for the rest of the scorekeeping participant's team members. The user interface includes a list of holes for entering a score along with entry fields for entering a score on a particular hole. The scorekeeping participant enters a score for each participant on the scorekeeping participant's team. After entering scores for each participant of the scorekeeping participant's team, the scores are saved and transmitted to the scoring database 16.

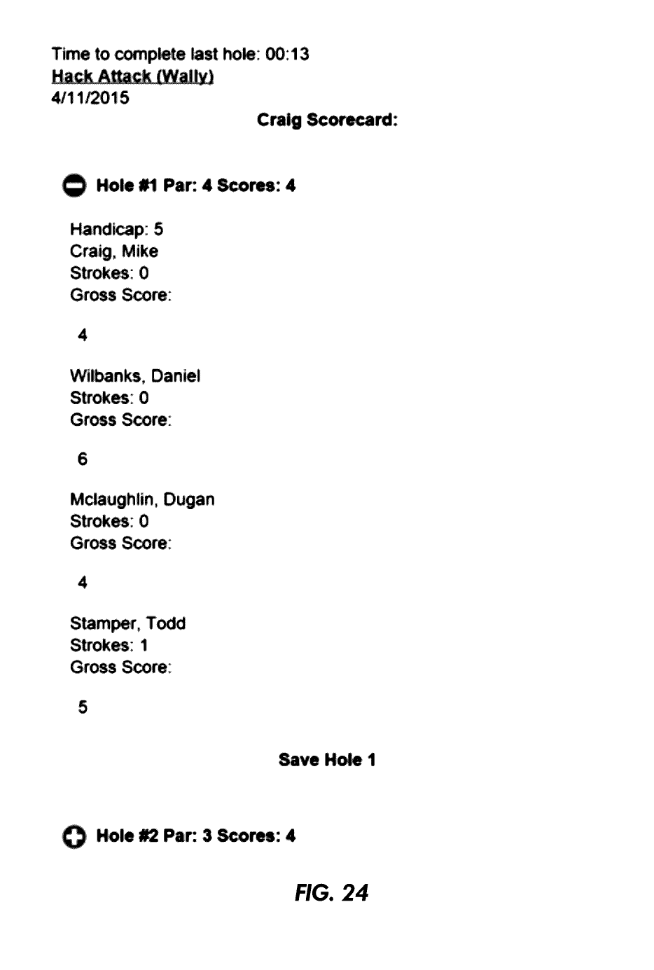

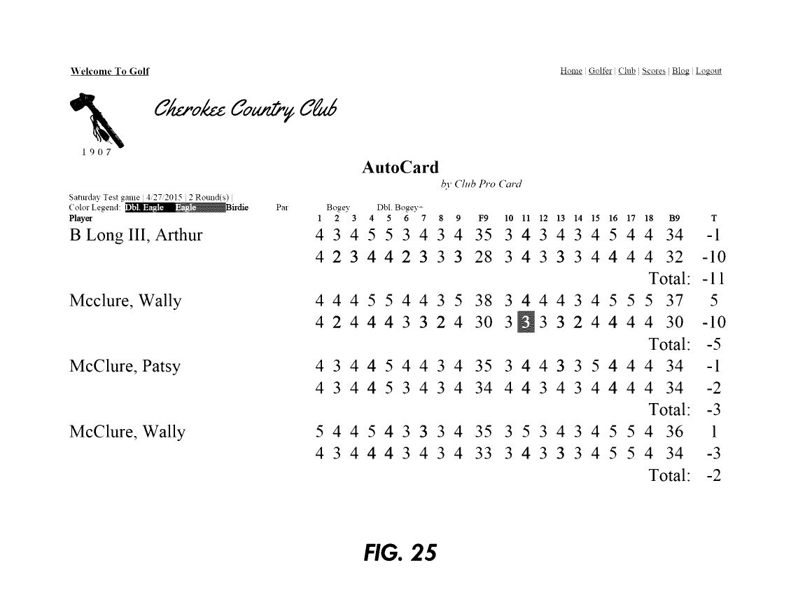

The user interface displayed to the scorekeeping participant preferably only allows input of a single hole score for participants of the playing group, as illustrated in FIGS. 2 and 24. The scorekeeping participant inputs a score for each participant in the playing group, and selects and save score or transmit score input on the user interface to transmit the playing group scores for the single hole to the scoring database 16.

The electronic golf scoring system 10 allows the scorekeeping participant to “hand off” scorekeeping to another participant on the scorekeeping participant's team for a variety of reasons, such as dying battery or inexperience with utilizing a personal device. The electronic golf scoring system 10 may automatically designate a captain as the scorekeeping participant in a particular game. It may be desirable to designate another participant on the captain's team as a scorekeeping participant. Referring now to FIG. 3, a list of participants on the scorekeeping participant's team is displayed on the participant device 12. The scorekeeping participant may select another participant on the scorekeeping participant's team to designate that participant as the new scorekeeping participant. Additionally, the administrator in the Pro Shop may “hand off” the score keeping responsibility should the scorekeeper's device become disabled.

The scoring database 16 receives a request from a scorekeeping participant's device requesting designation of a new group scorekeeper on the scoring database 16. The request includes data related to an identity of a participant within the scorekeeper's playing group as the participant to be designated as the new group scorekeeper. The scoring database 16 designates the identified participant as the new group scorekeeping participant, and generates a scorekeeper input page that is displayed on the participant device of the newly designated group scorekeeper such that the new scorekeeper may input scores of participants within the scorekeeper's group. The scoring database 16 may transmit an alert to the participant device of the newly designated scorekeeping participant to alert the participant of being designated as the group scorekeeper. Scores from the newly designated scorekeeping participant are stored on the scoring database 16. Further, access to the original scorekeeping input page by the originally designated scorekeeping participant may be revoked, such that only the newly designated scorekeeping participant may input scores for other participants of the playing group.

After designating the new scorekeeping participant, scorekeeping will be effectively handed off to the new scorekeeping participant. The new scorekeeping participant may then access the user interface of FIG. 3 such that the new scorekeeping participant may enter scores on behalf of the scorekeeping participant's team. The user interface of FIG. 3 may be accessed via a native App on the one or more participant devices 12. Alternatively, scorekeeping participant's may access the user interface of FIG. 3 via a web browser of the one or more participant devices. In one optional embodiment, scores entered by the scorekeeping participant may be stored on the participant device 12 and later transmitted to the scoring database 16, such as when the participant device 12 may lack the ability to connect to the scoring database 16 via the Internet. As known to the industry, a native App is software that resides on a device that provides for input, processing, output, storing, and transmission, as opposed to an application that is hosted on a remote device that processes, stores, and transmits via a web browser.

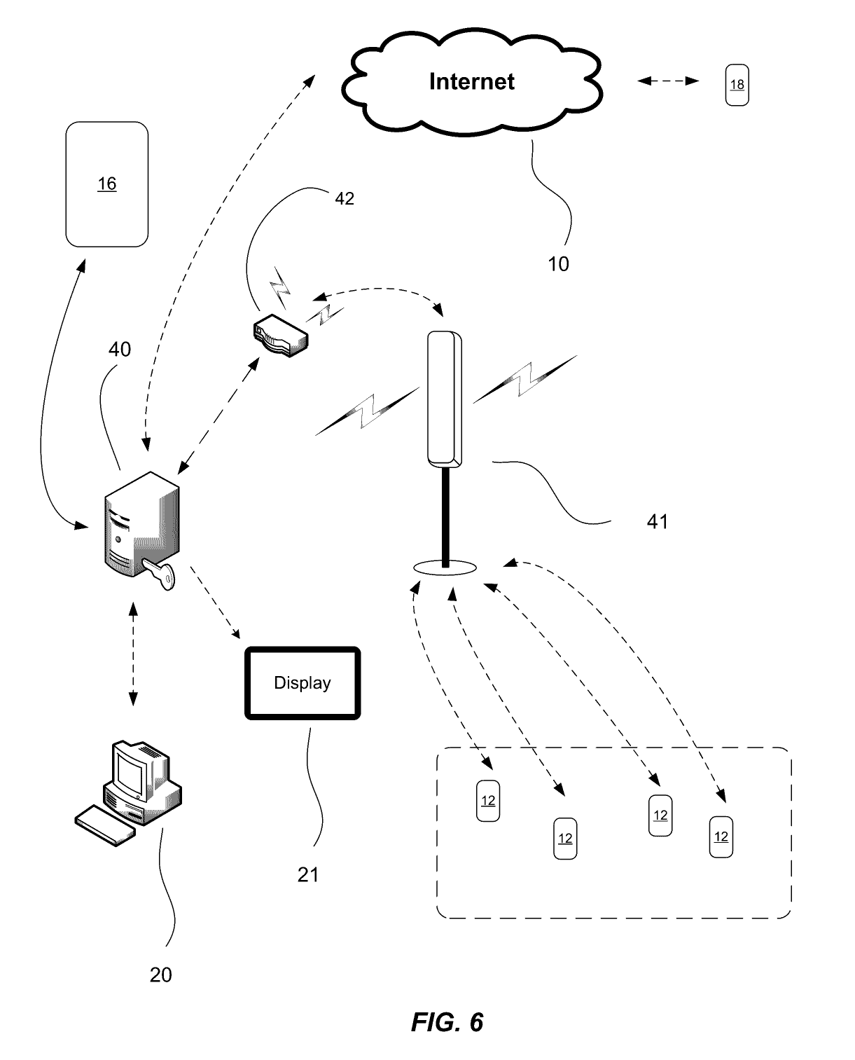

FIG. 6 illustrates an embodiment of the electronic scoring system wherein no outside infrastructure is required (such as the Internet, cellular communications, etc.) and the entire system utilizes a golf course dedicated infrastructure with communications between participant devices 12 data handled by a “Mesh” system 41 (such as Wi-Fi) or other like hardware.

Scores are preferably entered into one of the participant devices by the scorekeeping participant, however, it is also understood that a spotter or other third party following a particular group may enter scores. Further, scores may be entered at a conclusion of each hole, or each stroke may be entered as each shot is made such that each shot is recorded in real time in the scoring database 16, with the completion of each hole indicated at the appropriate time.

In one embodiment, participants may elect to have each participant's score submitted to the GHIN system. If elected, the scoring database 16 may transmit participant scores to the GHIN system along with participant GHIN numbers such that scores may be added to participants' GHIN profiles and the participants' handicaps updated accordingly.

While scores of all participant's for a particular playing group may only be received from a group scorekeeper, in one embodiment each individual participant may transmit the participant's individual score to the scoring database from the participant's device. The scoring database 16 may generate a scoring input form for each participant that includes an input field for only the score of the corresponding participant. The scoring database 16 receives a score input from the participant and compares the received score to a score received from the participant's playing group scorekeeper. The scoring database 16 may prioritize the received score from the individual participant such that if a score is received from both the group scorekeeper and the individual participant, the score received from the individual participant is stored on the scoring database and displayed on a real-time scoreboard as described below.

The scoring database 16 receives inputted scores from the group scorekeepers and associates the received scores with the appropriate participant and team of the participant. For example, if a group comprising four players includes one scorekeeper, but only two of the players of that group are on the same team, the scoring database 16 receives participant scores related to participants of multiple teams. The scoring database 16 sorts the received participant scores such that appropriate team scores are determined, and updates scoring to reflect team scores based on received data including scores corresponding to multiple teams.

Scores received on the scoring database 16 may be received in various formats. For example, the scoring database 16 may receive scores corresponding to a number of strokes of a participant for a given hole and determine a participant and team score based on the strokes. The scoring database may then determine participant and team scores for formats other than stroke play based on the received data related to a participant's stroke play score. Alternatively, a group scorekeeper may input scores related to an alternative format, such as a Stableford format score, and the scoring database 16 determines the number of strokes of the participant corresponding to the received format score.

### Real-Time Scoring and Scoreboard

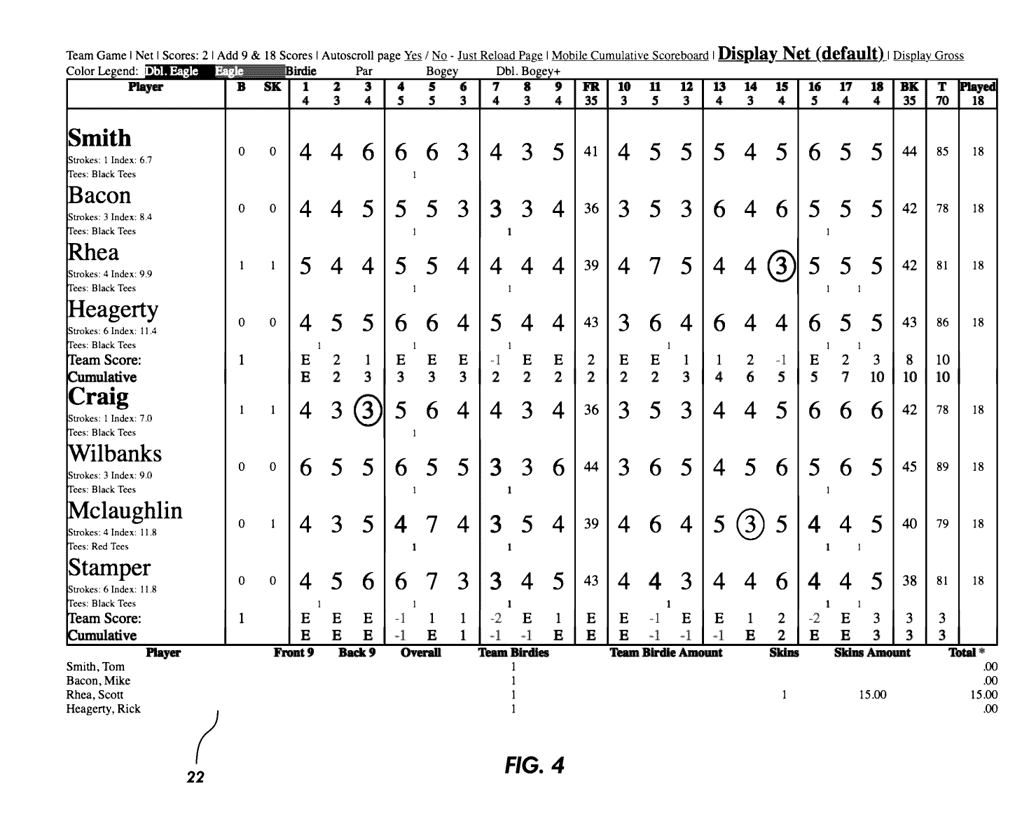

As scorekeeping participants enter scores into the scoring database 16, the scores are entered into a real-time scoreboard 22 (FIG. 4), which displays scores of various participants on the golf game as those scores are entered by the scorekeeping participants. Depending on the type of game being played, the real-time scoreboard 22 may display scores associated with each participant as well as an overall team score. Additionally, side game results may be displayed on the real-time scoreboard 22, such as real-time skins. Current status of all wagers may also be displayed.

The exemplary scoreboard of FIG. 4 displays scores associated with participants of a game. Specifically, the exemplary scoreboard 22 of FIG. 4 is associated with a game where a team is scored based on a team's two lowest scores on a particular hole and where a team's three lowest scores are counted on holes 9 and 18. In a first column, participant names are displayed along with each participant's handicap index, a number of strokes for the particular game, and designated tees of the participant. A second column of the exemplary scoreboard 22 displays a number of birdies and skins by each participant. The remaining columns display a hole number, a par value of each hole, and each participant's score on each hole, followed by cumulative totals for each participant. The handicap stroke adjustment for each player on each hole is shown in subscript in those columns. Below each group of participants on the same team a team score is shown for each hole along with a cumulative score for a team through each particular hole. As scorekeeping participants enter scores for each participant, the scoreboard 22 is updated such that the scores are displayed in real-time.

While the scoreboard of FIG. 4 shows one example of a low-ball team game, other scoreboards may be suitable for other various types of golf games. For example, in a scramble format, instead of individual scores for each participant the real-time scoreboard 22 may only display an overall team score for each hole. Similarly, in a match play game, instead of a cumulative score the real-time scoreboard 22 may display how many holes up or down a participant is relative to other participants of the game.

Scores displayed on the real-time scoreboard 22 may vary depending on who is viewing the real-time scoreboard. For example, a real-time scoreboard for participants may be provided as well as a real-time scoreboard for non-participating third parties. Each scoreboard may display various amounts of information and scores depending who is viewing the real-time scoreboard.

For example, when displaying a real-time scoreboard for participants, it may be desirable to limit a number of scores shown to the participants to scores for holes on which the participant has already submitted a score. If a participant logs in to the scoring database via the participant device 12, the scoring database may determine that the participant is currently active in a golf game and display a modified real-time scoreboard in response. In one embodiment, a real-time scorecard for a participant may only display scores of other participants through the most recently completed hole by all participants, thereby preventing the participant from viewing how other participants scored on a hole before the participant plays that hole. In one embodiment, the real-time scoreboard may not update other participant's scores for a particular hole until a scorekeeping participant enters the scorekeeping participant's team scores for that particular hole.

Alternatively, if a non-participating third party logs on to the scoring database from a third party device, the real-time scoreboard may display all current scores of participants in a particular golf game. The non-participating third party may then view a current status of a particular golf game along with scores of each participant through the most recent hole completed by each participant.

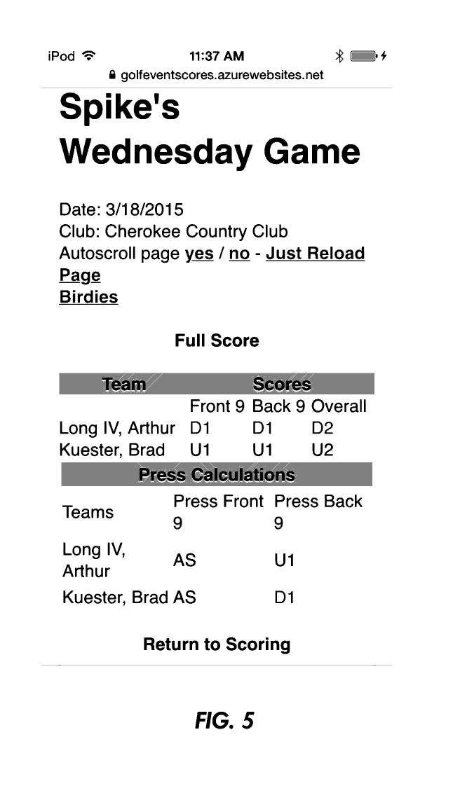

Participants may access the real-time scoreboard 22 through the one or more participant devices 12. For example, FIG. 5 illustrates a real-time scoreboard displayed on one of the participant devices 12. The example of FIG. 5 shows a real-time scoreboard related to a match play type event wherein “D1” indicates that a particular team is “1 down” and “U1” indicates that a particular team is “1 up.” Access to the real-time scoreboard may be achieved by logging in to the scoring database 16 using a set of credentials assigned to a particular participant. The participant may log in to a participant profile stored on the scoring database 16 via a browser of the participant device 12 or via a native application installed on the participant device.

Alternatively, after a game is created in the scoring database, a text message or email may be distributed to participants of a particular game. The text message or email may include a link to the real-time scoreboard. Participants may be authorized to view a particular scoreboard, such as by using a token associated with a particular participant. Similarly, a link to the real-time scoreboard may be distributed to various non-participating third parties such that those parties may view the real-time scoreboard. It may be desirable to send a text message or email including a link to the real-time scorecard to participant's who do not regularly participate in a particular game or otherwise maintain a participant profile on the scoring database 16.

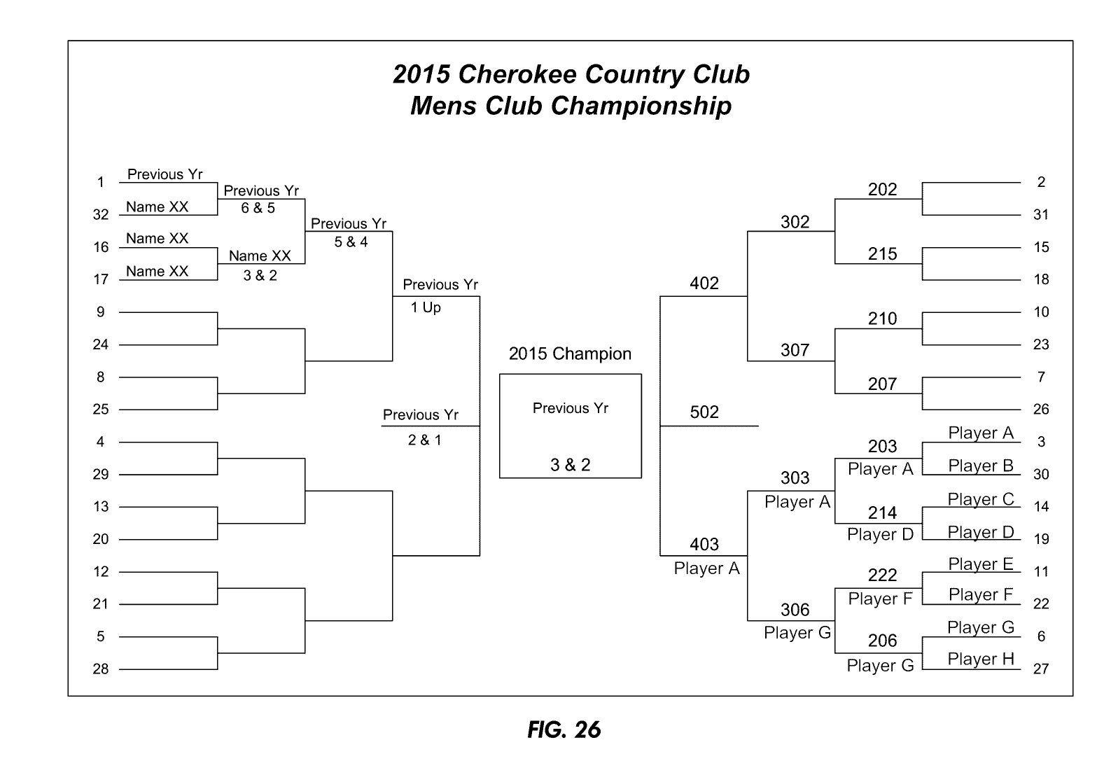

In addition to the real-time scoreboard, other various results may be generated by the scoring database 16 and displayed on the one or more participant devices 12 or other displays. For example, in a stroke play event in which participants are playing to determine seeding for a subsequent match play event, the scoring database 16 may generate real-time rankings of participants based on that participant's real-time score during a round. Further, an active and real-time projected bracket may be generated and displayed showing anticipated matches to be played based on real-time scoring of the participants such that third parties may view in real-time potential matchups. An exemplary real-time bracket is shown in FIG. 26.

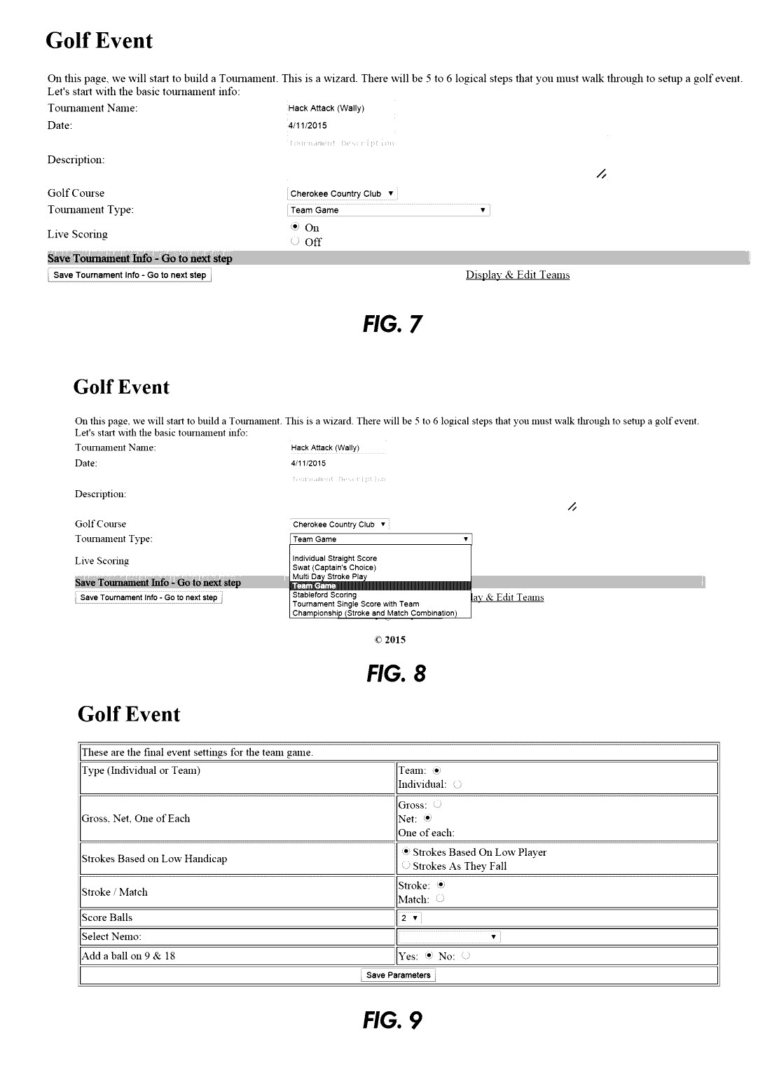

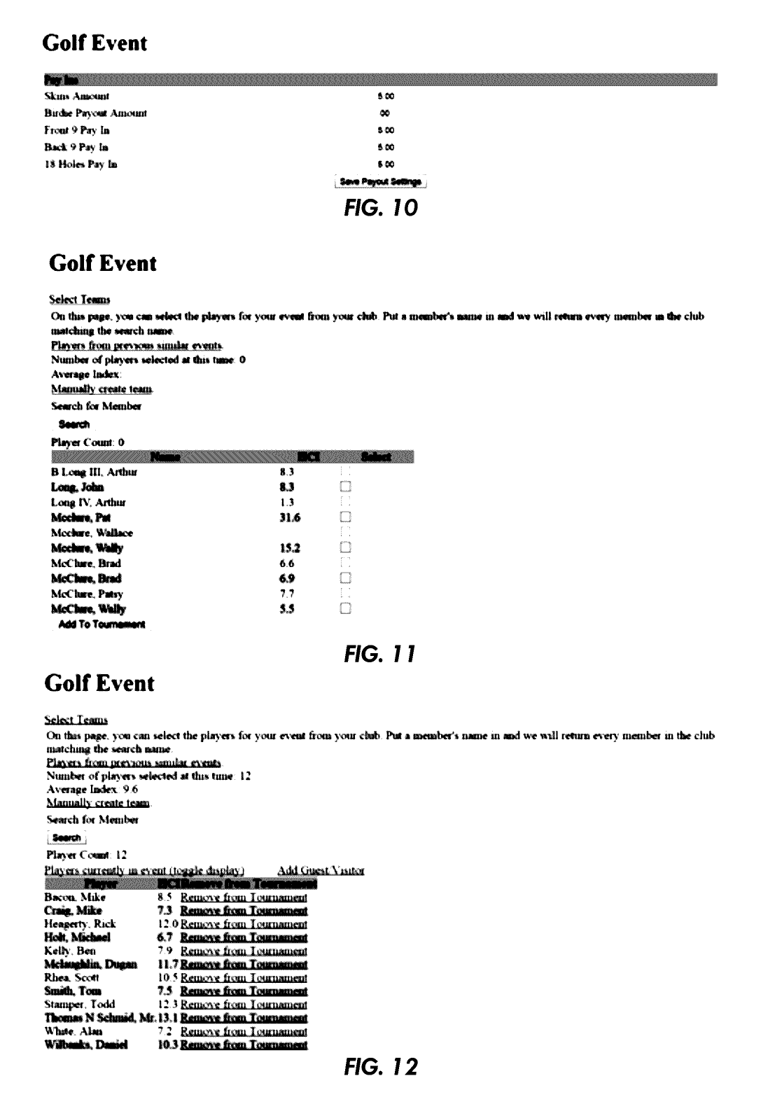

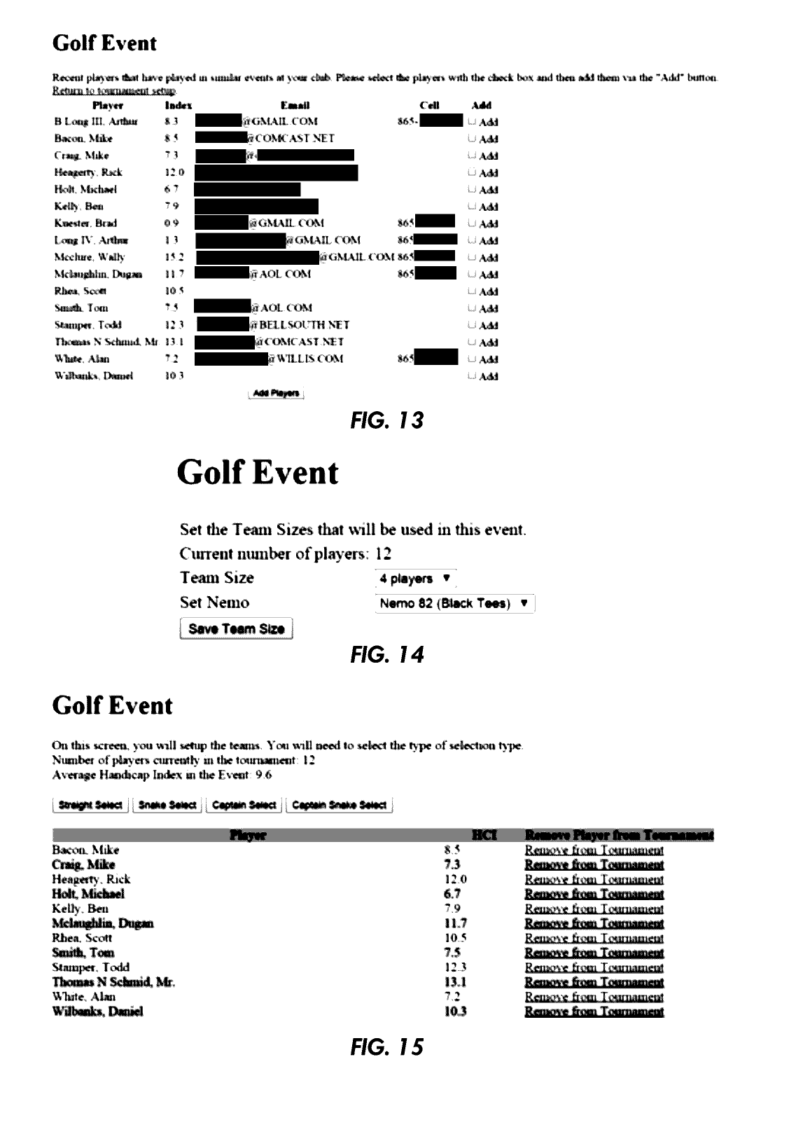

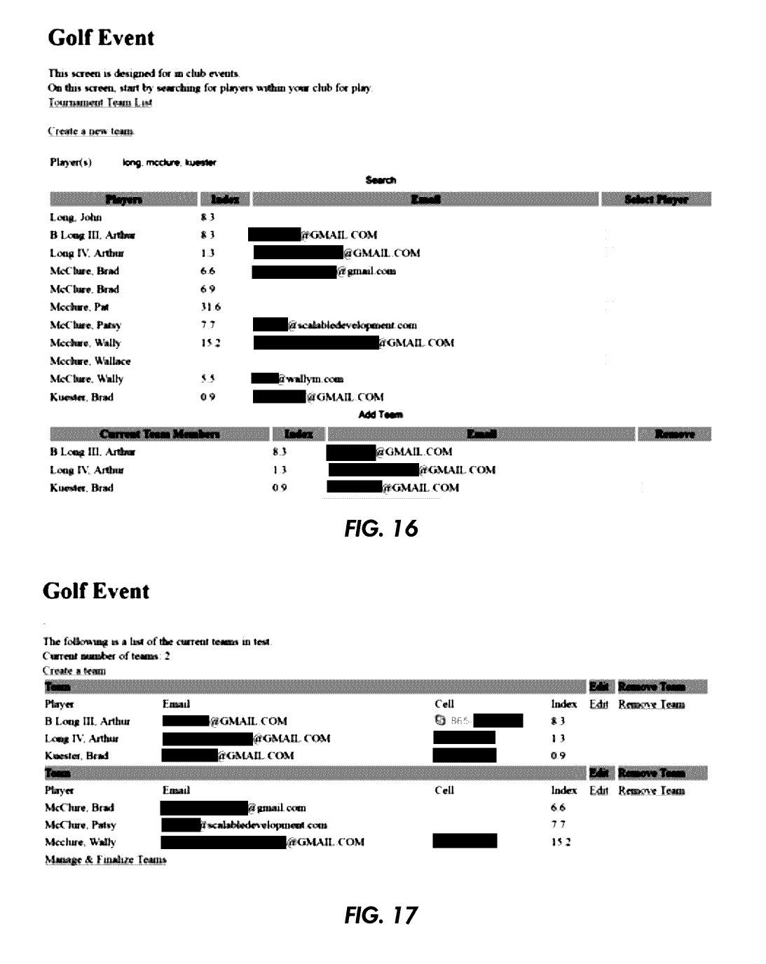

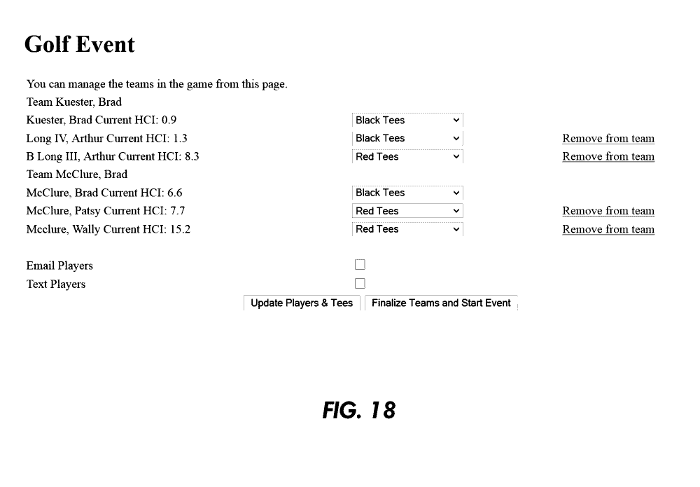

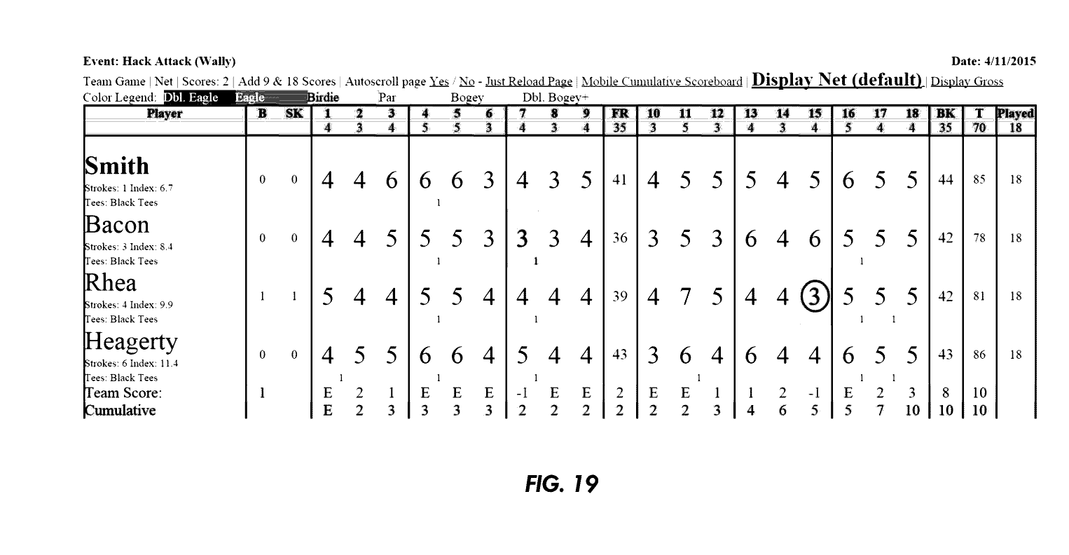

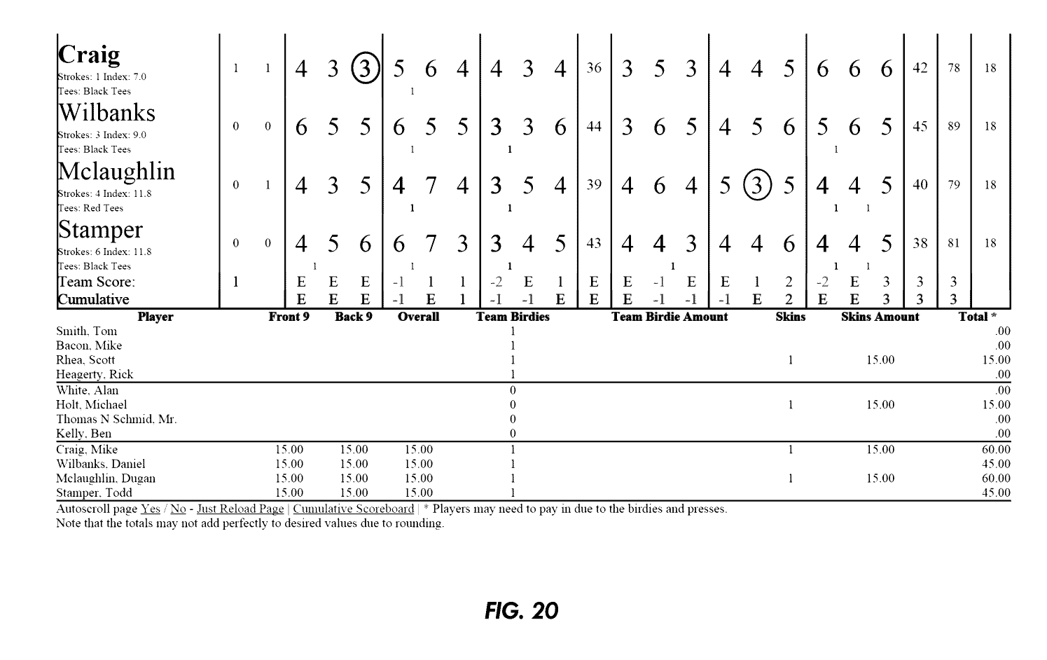

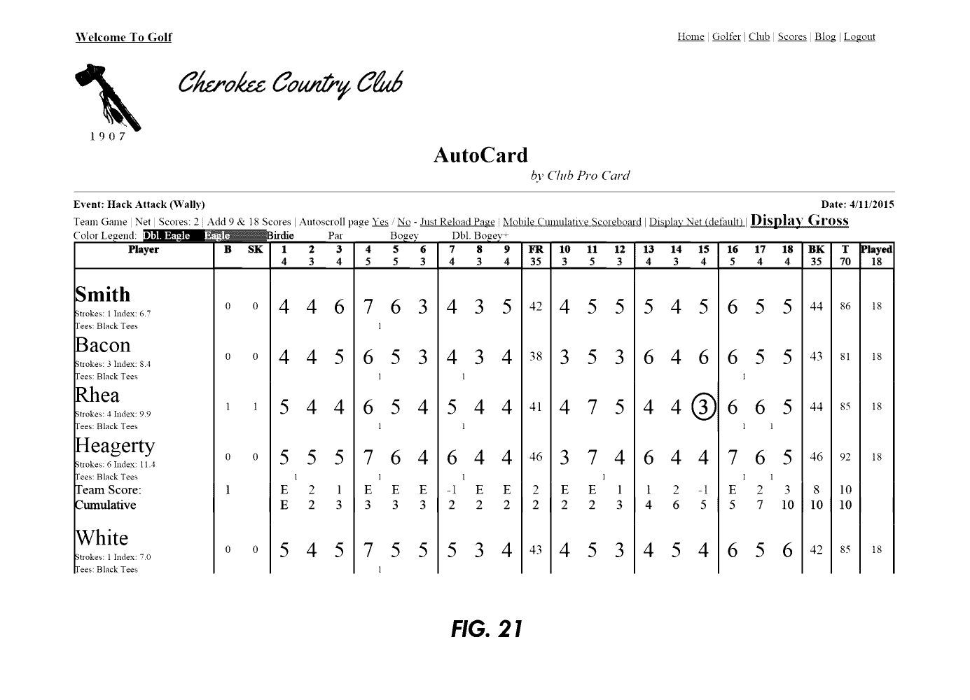

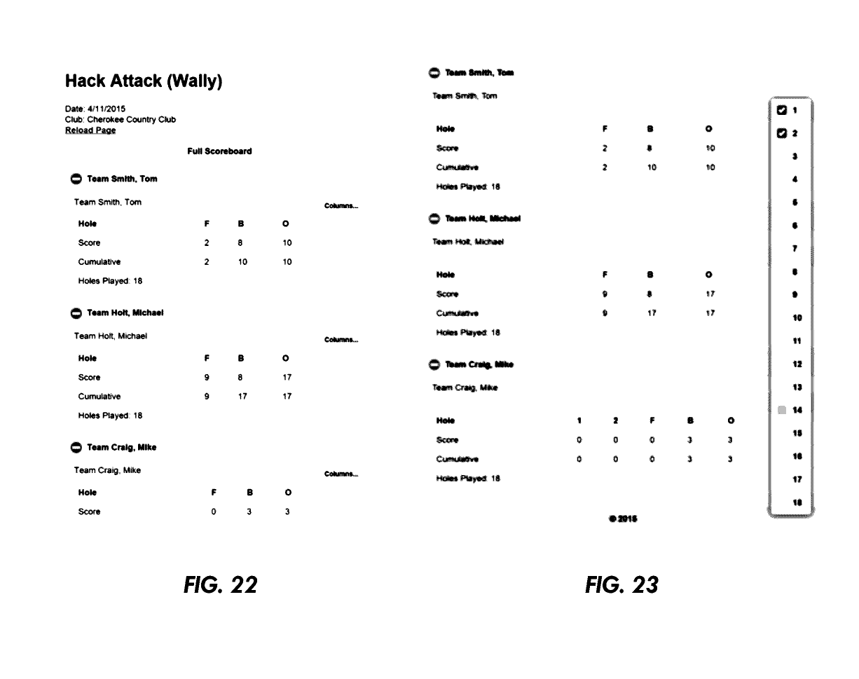

Other results displayed on a particular real-time scoreboard may include real time wager results. For example, FIG. 7 shows results of wagers placed on a particular game, and potential earnings may be updated based on real-time scores entered by the participants, such as whether any skins were awarded on a particular hole after all participants have played that particular hole. Displayed wager results may include results for a front nine of a round, a back nine of a round, and the overall results for a full round of golf. Other various results may be displayed such as greenies, sandies, presses, closest to the hole, and other results during a game.

In one embodiment, a display such as a television or other screen is positioned at a viewing location(s) at a particular golf course (FIG. 1 item 21). The display is in communication with the scoring database such that one or more viewers may view real-time scores of participants in a golf game occurring at the golf course.

The real-time scoreboard and results generated by the scoring database 16 further include real-time “net” scores that are based on handicap data or tee locations of participants in the particular golf event being scored. The scoring database 16 automatically updates the scoreboard based on any changes to participant handicaps or tee locations received on the scoring database 16 while an event is underway. For example, if it is discovered that a participant is playing from an incorrect tee location or that a handicap for a particular participant was incorrect entered, a corrected handicap or tee location may be transmitted to the scoring database 16. The scoring database 16 associates the updated handicap or tee location information and automatically updates the generated scoreboard based on the updated information such that scores displayed on the scoreboard are amended in real-time.

The real-time scoreboard may include additional data related to participants and participant teams, such as photos of participants, participant nicknames, and other data related to participants. Data related to participants is received on the scoring database 16 from the one or more participant devices and stored on the scoring database 16.

### Performance Tracking

The electronic golf scoring system may also track performance and other data related to participant's playing in a particular game of golf. Data stored on the scoring database 16 may be stored in a participant profile and associated with other information related to the participant, such as the participant's contact information, email address, GHIN number, and handicap index.

In one embodiment, the electronic golf scoring system tracks a pace of play of participants in a particular golf game. As scorekeeping participants enter scores into the participant devices 12 and transmit those scores to the scoring database 16, each scoring entry may be time stamped based on when participants entered scores into the participant devices 12. Time stamped entries are further correlated to each particular hole played by each participant along with a total time of play.

Based on this information and the same information for groups of participants in front of a current group of participants, the scoring database 16 may determine whether a group is maintaining an appropriate pace of play by determining an average amount of time that participants require to complete a hole during the golf game. An amount of time to complete a golf hole may be determined by measuring when participants enter scores into the participant devices. An average pace of play may be stored in the scoring database 16 and associated with participants, and average pace of play may be updated each time that participants transmit scores to the scoring database 16 from the participant devices 12.

Pace of play information may be further transmitted from the scoring database 16 to the clubhouse device 20. The clubhouse device 20 may display real-time pace of play data related to participants in a golf game such that golf course professionals or other staff may monitor a pace of play of participant's playing in a golf game at a golf course. A staff member or club professional may designate a desired range of average pace of play and enter the desired range into the scoring database 16 via the clubhouse device 20. The pace of play may be adjusted by a staff member or professional of a course based on factors such as conditions (i.e. weather) or tournament play. If a participant or group of participants falls below the desired range of pace of play, an alert may be generated on the clubhouse device 20 to alert a staff member or club professional that a particular group has fallen out of position on the golf course. Further, an optional alert may be sent to participant devices 12 of the out of position group to alert participants in that group that the group's pace of play has slowed.

Scoring data entered by participants into the scoring database 16 via the participant devices 12 may also be used to track participants' performance over a given time period. In one embodiment, the electronic golf scoring system 10 tracks participants' performance at a particular golf course and for each particular hole. For example, when a participant plays in a format that includes entry of the participant's score on every hole of the golf course, the scoring database 16 stores data related to how the participant performs on each particular hole over time. Participant data is affiliated with the participant and stored on the scoring database 16. Each participant may generate a report displayed on the participant device 12, such as a report showing trends in the participant's performance on each hole, the participant's performance on certain types of holes (e.g., par 5s, par 3s, dogleg holes, etc.). Participant reports may be generated upon transmitting a request to the scoring database 16 or, alternatively, may be sent on regular periodic intervals, such as monthly reports sent by email to each participant.

Additional data may be stored on the scoring database 16 such as total wager amounts and winnings by each participant over a given period of time. After a golf game is complete and winnings determined, each participant's winnings may be stored in a profile of the participant on the scoring database 16. Each participant may request a report from the scoring database 16 regarding the participant's total winnings or losses over a particular period of time. Each participant may further request reports related to winnings associated with different types of games played by the participant, thereby allowing the participant to view which types of games are more likely to result in winnings for the participant. Additionally, an overall leaderboard may be stored in the scoring database 16 listing overall leaders in winnings for particular games, such as regular weekly games including substantially the same participants. To ease payments and receipts of wagers, entry in an event may be predicated on enrollment in an auto-payment system developed and maintain by third parties, so that at the completion of a game funds are automatically transferred between parties as calculated by the system.

In addition to performance data stored on the scoring database 16 for the retrieval and benefit of participants, data related to a particular golf course may also be stored on the scoring database 16 for retrieval by a golf course. Data stored in the database may include scoring performance relative to particular pin positions of a golf course based on a location of a pin during a particular event, assigning a handicap difficulty to holes on a particular golf course based on participant performance on each hole for subsequent match play or stroke play handicaps, and other data related to the particular golf course. Data related to participant performance may be transmitted to various golf associations such that the golf associations may analyze data related to participant performance, such as pace of play and scoring on particular types of golf courses.

The electronic golf scoring system 10 of the present disclosure advantageously enables a group of participants in a golf game to track scores and other related data of the golf game without requiring substantial infrastructure of a golf course and without requiring third party scorers to follow the group of participants. While traditional electronic scoring has required scoreboards placed throughout a golf course and installation of substantial infrastructure including radio transmitters and personnel to man such infrastructure, the electronic golf scoring system 10 allows participants of an informal golf event to score the event, monitor scores during the event, and quickly determine results upon conclusion of the golf event. Further, third party non-participants in the golf event may access a scoreboard stored on the scoring database 16 to view real-time results of a golf event, and allows participants to view real-time results of other competitors in a particular golf game. The electronic golf scoring system 10 also reduces an amount of time required to determine which participants have won a particular event.

In addition to providing a real-time scoring system for informal golf games without requiring substantial resources at a golf course, the electronic golf scoring system also provides accumulated data analysis of participants' performance over a given period of time. Participants may retrieve reports showing a participant's performance at particular golf courses or on particular golf holes, along with the participant's accumulated winnings in a particular golf game or over a period of time.

Because the scoring database 16 is preferably remote from a golf course and in communication with the participant devices 12 via a wireless connection such as a cellular radio, the electronic golf scoring system 10 is readily deployable at various golf courses without requiring any resources of the golf course. Additionally, golf courses may also retrieve reports related to participants' performance at a particular golf course, such as scoring averages and pace of play. However, should a golf course desire to utilize a system that is independent from any outside infrastructure, FIG. 6 illustrates an embodiment that may be utilized based on a “Mesh” network 41 such as Wi-Fi or other like system, such as by using a router 42 in communication with a file server 40.

### Side Games

One or more participants of a golf game may set up a “side game” between individual participants of the golf game that runs concurrently with the golf game. To set up a golf game, the scoring database generates a side game form accessible on the participant devices. The side game form displays a list of golf game participants, wherein a participant may select one or more other participants as members of the side game. After selecting the participants, a participant may select one or more inputs related to a game type and parameters of the side game. For example, game types could include match play, stroke play, and other various types of side games. Further, the participant may select whether the game is to be scored based on a participant's gross score or net score of the participant that factors in the participant's handicap rating.

The scoring database 16 receives data from the participant device related to the side game and generates a side game that is stored on the scoring database 16. The participants identified in the received data as participants of the side game are then associated with the side game on the scoring database 16. A side game scoreboard is generated on the scoring database 16 and may be displayed on the participant devices or on a display.

As the scoring database 16 receives participant scores from the group scorekeepers, the scoring database 16 updates a side game score in real time and displays the side game score on the generated scoreboard. Scores are preferably received from the group scorekeepers and associated with the participants of the side game and are updated in real-time as scores are received on the scoring database 16.

### Event Planning

In one embodiment, the scoring database 16 generates a third party planner input page to enable a third party, such as an event planner, to input data related to a desired golf event and store data related to the golf event on the scoring database 16. A golf game may then be generated on the scoring database 16 based on data received from the third party planner.

For example, if a corporate event desires to host a golf event as part of the corporate event, a planner of the corporate event may access the third party planner input page on a planner device and input information such as identifying data related to one or more participants, a game type, event rules, location, and other information related to a desired event. The scoring database receives data entered by the third party planner and creates an event stored on the scoring database. Data related to the event is preferably received on the scoring database from the third party planner in advance of a date of the event.

On or close to the date of the event, either the third party event planner or a clubhouse device may access the scoring database 16 and initiate the event. Upon initiating the event, the scoring database 16 proceeds to generate appropriate scorekeeper input pages and assign teams designated for the event.

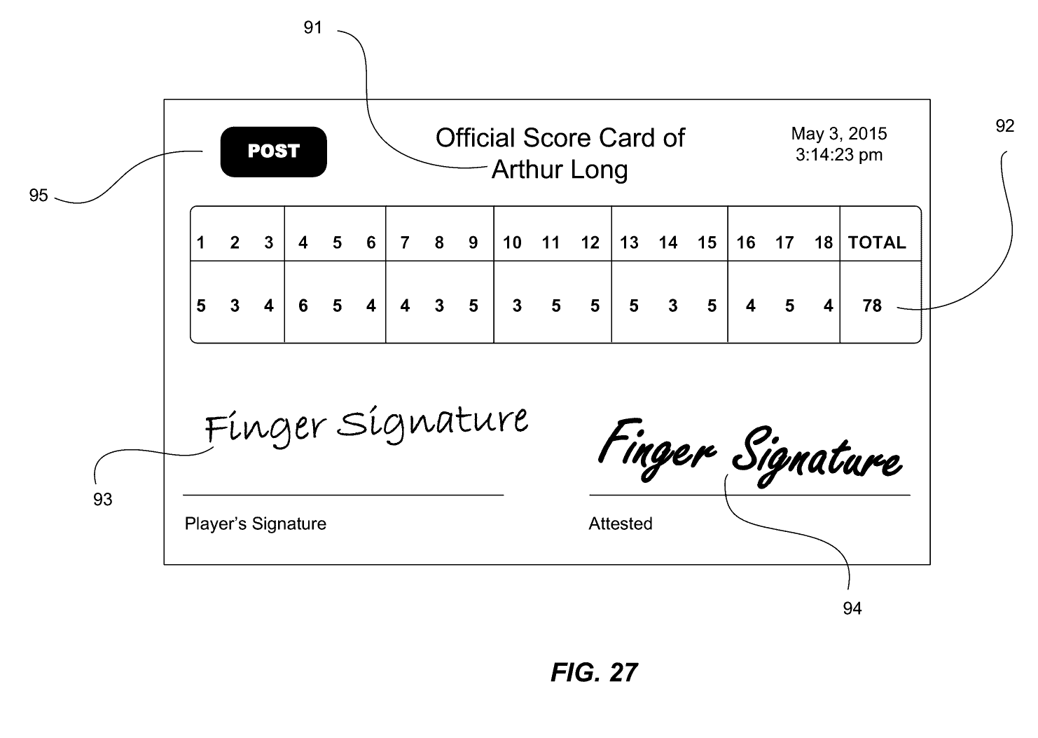

### Tournament Official Posting and Recording

Whereas certain events, such as tournaments, require a scorecard to be verified and signed by the player and attested by the player's playing partner, in one embodiment the system creates a completed scorecard FIG. 27 on a tablet that displays the players name 91, the players score by hole and in total 92, provides for the player's signature using his figure or a stylus 93 and the attesting parties signature 94, and a method to enter, time stamp, and record the scorecard.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method for electronically scoring a golf event by participating members of a golf group, the method comprising:
providing a scoring database including a processor and one or more computer readable storage mediums, the scoring database in wireless communication with a plurality of participant devices, each of the plurality of participant devices including a user interface;
storing on the computer readable storage medium of the scoring database data related to an identification of a plurality of participants in a golf game;
assigning each of the plurality of participants in a golf game to one of a plurality of playing groups competing in the golf game;
designating on the scoring database one of the plurality of participants in each playing group as the group scorekeeper;
generating a scorekeeper input page displayed on the participant device of the designated group scorekeeper comprising a list of each participant assigned to the group scorekeeper's playing group;
generating a golf game scoreboard viewable on a display, the golf game scoreboard including real-time score of participants in the golf game;
receiving participant individual hole scores for each member of the designated group scorekeeper's playing group on the scorekeeper input page displayed from the participant device of the group scorekeeper;
storing the received participant hole scores on the computer readable storage medium of the scoring database and associating the received score with each participant on the scoring database; and
updating the generated golf game scoreboard to display scores of the golf game based on received participant individual hole scores received from the participant device of the group scorekeeper.

2. The method of claim 1, further comprising:
receiving a request from a participant device of a group scorekeeper requesting designation of a new group scorekeeper on the scoring database, the request including an identity of another participant in the scorekeeper's playing group;
designating the identified participant in the scorekeeper's playing group as the new group scorekeeper on the scoring database;
generating a scorekeeper input page displayed on the participant device of the newly designated group scorekeeper; and
receiving participant individual hole scores for each member of the designated group scorekeeper's playing group on the scorekeeper input page displayed from the participant device of the new group scorekeeper.

3. The method of claim 2, further comprising transmitting a notification to the participant device of the participant identified in the designation request to notify the participant that the participant is now the group scorekeeper.

4. The method of claim 1, further comprising:
receiving a request from a participant device to initiate a side game, the request including identification of one or more other golf game participants and a side game format;
generating a side game on the scoring database based on the received request and associating the side game with the identified golf game participants;
generating a side game scoreboard, the side game scoreboard based on individual hole scores received on the scoring database from the participant device of the group scorekeeper.

5. The method of claim 4, wherein the format of the side game is different from the golf game format.

6. The method of claim 1, further comprising:
assigning the participants in the golf game into two or more teams, an identity of the teams stored on the scoring database;
assigning a golf game format to the two or more teams stored on the scoring database;
determining on the scoring database a score of the golf game based on the assigned golf game format and scores received on the scoring database from one or more group scorekeepers of the golf game;
wherein the generated golf game scoreboard includes the determined team score of the golf game.

7. The method of claim 5, wherein scores received from at least one group scorekeeper include scores corresponding to participants of more than one team within the same group, and wherein the scoring database associates the received scores of participants from more than one team into the correct team scores.

8. The method of claim 1, wherein the generated scorekeeper input page displays an input field for entry of a single hole score.

9. The method of claim 1, further comprising providing clubhouse device in electronic communication with the scoring database.

10. The method of claim 1, further comprising:
receiving a request from a clubhouse device in electronic communication with the scoring database requesting designation of a new group scorekeeper on the scoring database, the request including an identity of another participant in the scorekeeper's playing group;
designating the identified participant in the clubhouse device request as the new group scorekeeper on the scoring database;
generating a scorekeeper input page displayed on the participant device of the newly designated group scorekeeper; and
receiving participant individual hole scores for each member of the designated group scorekeeper's playing group on the scorekeeper input page displayed from the participant device of the new group scorekeeper.

11. The method of claim 9, further comprising receiving an identity of participants in a golf game and a golf game format on the scoring database from the clubhouse device.

12. The method of claim 1, further comprising:
receiving on the scoring database data related to a handicap rating of one or more participants of the golf game;
associating the received handicap data with the one or more participants of the golf game; and
determining on the scoring database a net score of one or more participants of the golf game based on the received participant handicap data and the participant scores received from the group scorekeeper.

13. The method of claim 1, further comprising determining on the scoring database a pace of play of a group based on a time at which the scoring database receives participant hole scores from the group scorekeeper.

14. The method of claim 1, further comprising:
generating an event web page accessible by an event planner device, the web page including one or more data fields for receiving data related to an identity of one or more participants in a golf event and a format of a golf event;
creating a golf event on the scoring database based on data entered by an event planner on the event web page;
grouping the one or more identified participants into two or more teams on the scoring database;
grouping the one or more identified participants into two or more playing groups on the scoring database; and
designating one participant from each of the two or more playing groups as a group scorekeeper.

15. The method of claim 1, further comprising transmitting a hyperlink to the plurality of participant devices in communication with the scoring database, the hyperlink including a token generated on the scoring database that is associated with a particular participant.

16. The method of claim 1, further comprising:
generating a non-scorekeeping participant input page displayed on non-scorekeeping participants of the playing group;
receiving a hole score for the non-scorekeeping participant from participant device of the non-scorekeeping participant;
storing the received participant hole score on the computer readable storage medium of the scoring database and associating the received score with the particular non-scorekeeping participant; and
updating the generated golf game scoreboard to display the received participant hole score, wherein the displayed participant score hole replaces the score received from the participant device of the group scorekeeper.

17. A method for electronically scoring a golf event by participating members of a golf group, the method comprising:
providing a scoring database including a processor and one or more computer readable storage mediums, the scoring database in wireless communication with a plurality of participant devices, each of the plurality of participant devices including a user interface;
storing on the computer readable storage medium of the scoring database data related to an identification of a plurality of participants in a golf game;
assigning each of the plurality of participants in a golf game to one of a plurality of playing groups competing in the golf game;
designating on the scoring database one of the plurality of participants in each playing group as the group scorekeeper;
generating a scorekeeper input page displayed on the participant device of the designated group scorekeeper comprising a list of each participant assigned to the group scorekeeper's playing group;
generating a golf game scoreboard viewable on a display, the golf game scoreboard including real-time score of participants in the golf game;
receiving participant individual hole scores for each member of the designated group scorekeeper's playing group on the scorekeeper input page displayed from the participant device of the group scorekeeper;
storing the received participant hole scores on the computer readable storage medium of the scoring database and associating the received score with each participant on the scoring database;
updating the generated golf game scoreboard to display scores of the golf game based on received participant individual hole scores received from the participant device of the group scorekeeper;
receiving a request from a participant device of a group scorekeeper requesting designation of a new group scorekeeper on the scoring database, the request including an identity of another participant in the scorekeeper's playing group;
designating the identified participant in the scorekeeper's playing group as the new group scorekeeper on the scoring database;
generating a scorekeeper input page displayed on the participant device of the newly designated group scorekeeper; and
receiving participant individual hole scores for each member of the designated group scorekeeper's playing group on the scorekeeper input page displayed from the participant device of the new group scorekeeper.
